(19) United States
(12) Patent Application Publication
(10) Pub. No.: US 2013/0341019 A1
(43) Pub. Date: Dec. 26, 2013

(54) REMEDIATION AND EXTRACTION METHODS USING CITRUS BASED SOLVENTS

(71) Applicant: Jim VAN WERT, Carstairs (CA)

(72) Inventor: Jim VAN WERT, Carstairs (CA)

(21) Appl. No.: 13/922,799

(22) Filed: Jun. 20, 2013

Related U.S. Application Data
(60) Provisional application No. 61/662,013, filed on Jun. 20, 2012.

(51) Int. Cl. B01J 19/10

(52) U.S. Cl. CPC B01J 19/10
USPC 166/268; 208/390

(57) ABSTRACT

The present invention relates to methods of extracting hydrocarbons from an oil matrix, either above the surface or in site in an oil deposit and to methods for treating soils contaminated with hydrocarbons and other contaminants. The methods of the present invention are based on the use of a citrus-based solvent and ultrasound energy to extract hydrocarbons from an oil matrix and to treat soils contaminated with organic and/or inorganic contaminants.

### FIELD OF THE INVENTION

The present invention relates in general to methods involving the use of a citrus-based solvent for the recovery of usable hydrocarbons from oil matrices and for treating soils contaminated with inorganic and/or organic contaminants.

### BACKGROUND OF THE INVENTION

Oil sands, which may also be referred to as tar sands, are a type of unconventional petroleum deposit. The oil sands consist essentially of a matrix of bitumen, sand, water and clay which has a very high viscosity and is therefore practically immobile. The bitumen may be some times defined as a form of extra heavy oil and is extremely difficult to extract.

Methods used to separate the bitumen from the sand require significant energy, chemicals and/or water. In certain circumstances, the sands can be extracted by strip mining, or the bitumen can be made to flow into wells by in situ techniques, which reduce the viscosity by injecting steam, solvents, and/or hot air into the sands.

Presently, SAGD, (steam assisted gravity drainage), is most commonly used to extract the bitumen from the deposits below 400 m depth (http://www.globaloilsands.com/Mining/index.shtml). The SAGD process requires vast amounts of water and natural gas and has, therefore, a large environmental impact.

Once separated from the sand, lighter oils and hydrocarbons can be obtained from crude oil and heavier hydrocarbons through cracking processes involving distillation of crude oils in processing plants. Cracking, or refining, is the overall reduction of lengths of hydrocarbon chains, usually alkanes.

Methods used to distil and process lighter from heavier hydrocarbons require significant use of energy and processing infrastructure. Raw crude hydrocarbons are extracted from deposits, piped, or delivered in some other manner to distillation plants, and submitted to cracking processes known as refining. Heavier oils, particularly bitumen, may need to be mixed with solvents in order to facilitate delivery.

Ultrasonics has been attempted for in situ oil sand extraction processes previously but only using water as an ultrasonic media. Ultrasonics requires some media for sound to travel through in order for sound to come into contact with oil sand.

PCT/CA2011/001120 relates to a method for separating, extracting and refining hydrocarbons from a hydrocarbon matrix, such as oil sand or oil shale without addition of a polar liquid such as water, or with the addition of relatively small amounts of polar liquids. This PCT application relates to the use of ultrasonics and non-polar substances, to recover hydrocarbons, including bitumen, from a hydrocarbon matrix such as those found in oil sands, carbonate formations, or oil shale both in situ and in formation without the addition or requirement of water. However, in cases where there is a high level of water present, for example as a result of a previous SAGD or high water levels present, other methods may be necessary to extract further oil products economically and with low environmental impact.

At present there is also a need for an efficient and environmentally friendly way of treating soils contaminated with salts and other pollutants.

About 20 percent of Canada's oil, sands resources can be accessed using mining techniques. Like other mining operations worldwide, oil sands mining operations generate leftover material (tailings) after the bitumen is extracted. Oil sands tailings contain a mixture of solvent and naturally occurring clay, sand, fine silts, water, residual bitumen, salts, metals and organic compounds. The sand component of the waste tailings settles out quickly, leaving the clay and silt component to form fluid fine tailings, which are stored in ponds at oil sands mining operations and left to settle. Once settled, the reclamation process can proceed with soils and contaminated media being transported to toxic waste sites or buried.

U.S. Pat. No. 5,690,511 discloses a method for extracting oil from oil-contaminated soils containing between 2 to 5 wt. % oil which consists of contacting the contaminated soil with a solvent in the presence of sonic energy. The solvents used in this disclosure, however, include petroleum-derived chemicals such as light crude oil, condensate, raw gasoline, kerosene and toluene. Not only these solvents may be considered soil pollutants, but also, due to their poor miscibility in water, they do not work in the reclamation of soils containing water, such as soils from tailing ponds.

d-Limonene is a biodegradable solvent that have earned acceptance in many applications. d-Limonene can be used in pure form, blended with other solvents, or emulsified to make water soluble solvent. d-Limonene is 100% bio-based and is GRAS (Generally Recognized As Safe) rated. To the knowledge of the applicants, d-Limonene nor any other citrus-based solvent has been used to remove salt contaminants from soil.

Accordingly, what is also needed is an inexpensive method of separating and treating soils contaminated with salts and/or oils so that the soils can then be returned to their original locations and not require burial or transportation to toxic waste sites.

### SUMMARY OF THE INVENTION

It is an object of the present invention to provide for methods of extracting heavy crude from an oil deposit.

Another object of the invention is to provide for a method for treating soils contaminated with one or more contaminants, including salts, oils and/or metals.

It is an object of the present invention to provide for a method for treating contaminated soils that result in clean soils that meet environmental standards in order to be returned to their original sites.

It is an object of the present invention to provide for a method for treating contaminated soils using environmentally friendly solvents that result in clean sons that meet environmental standards in order to be returned to their original sites.

As such, in one embodiment, the present invention provides for a method of extracting hydrocarbons from a hydrocarbon matrix. The method, in one embodiment, includes: (a) contacting the hydrocarbon matrix with a solution comprising a citrus based solvent to form a mixture, (b) subjecting the mixture to ultrasonic energy, and (c) extracting the hydrocarbons from the hydrocarbon matrix.

In another embodiment of the method of extracting hydrocarbons from a hydrocarbon matrix of the present invention, prior to step (a) the method comprises mining the hydrocarbon matrix from an oil deposit.

In another embodiment of the method of extracting hydrocarbons from a hydrocarbon matrix of the present invention, the hydrocarbon matrix is in an oil deposit.

In another embodiment of the method of extracting hydrocarbons from a hydrocarbon matrix of the present invention, the hydrocarbon matrix is in an oil deposit, and step (a) comprises contacting the hydrocarbon matrix in the oil deposit with the solution comprising a citrus based solvent, step (b) comprises subjecting the oil deposit having the citrus-based solvent to the ultrasonic energy: and step (c) comprises extracting the hydrocarbons from the oil deposit.

In another embodiment of the method of extracting hydrocarbons from hydrocarbon matrix of the present invention, the hydrocarbon matrix is in an oil deposit and the oil deposit includes water.

In another embodiment of the method of extracting hydrocarbons from a hydrocarbon matrix of the present invention, the hydrocarbon matrix is in an oil deposit that includes a spent Steam Assisted Gravity Drainage (SAGD) well, and wherein step (a) comprises pouring or injecting the citrus-based solvent into the spent SAGD well, step (b) comprises subjecting the oil deposit having the citrus-based solvent to the ultrasonic energy; and step (c) comprises extracting the hydrocarbons from the oil deposit.

In one embodiment, the present invention provides for an in situ method of extracting hydrocarbons from an oil deposit, the method, in one embodiment, includes: (a) contacting the hydrocarbons in the oil deposit with a solution comprising a citrus based solvent, (b) subjecting the oil formation having the citrus based solvent to ultrasonic energy, and (c) extracting the hydrocarbons from the oil deposit.

In one embodiment of the in situ method of the present invention, the method is a method extracting oil from a spent Steam Assisted Gravity Drainage (SAGD) well, and step (a) includes pouring or injecting the citrus-based solvent into the spent SAGD well.

In one embodiment of the methods of extracting hydrocarbons from a hydrocarbon matrix of the present invention, the solution includes at least about 10% of the citrus-based solvent and water.

In another embodiment of the methods of extracting hydrocarbons from a hydrocarbon matrix of the present invention, the citrus-based solvent includes d-limonene.

In another embodiment of the methods of extracting hydrocarbons from a hydrocarbon matrix of the present invention, the hydrocarbon includes heavy crude oils.

In another embodiment of the methods of extracting hydrocarbons from a hydrocarbon matrix of the present invention, the hydrocarbon includes heavy crude oils.

In another embodiment of the methods of extracting hydrocarbons from a hydrocarbon matrix of the present invention, the oil deposit is selected from shale oil deposit, oil sand deposit or carbonate oil reservoirs.

In one embodiment the present invention provides for a citrus-based solvent process for remediating contaminated soil including: (a) contacting the contaminated soil with a solution comprising a citrus based solvent to form a mixture; (b) subjecting the mixture to ultrasonic energy for a time sufficient to cause an amount of the contaminates to separate from the soil; (c) removing the contaminates from the ultra-sonicated mixture thereby recovering remediated soil.

In one embodiment of the citrus-based solvent remediation process of the present invention, step (c) comprises subjecting the ultra-sonicated mixture to centrifugal forces for a time sufficient to separate the soil from the contaminates.

In another embodiment of the citrus-based solvent remediation process of the present invention, the contaminated soil contains an electrical conductivity of about 11 dS/m or more, and the recovered soil has an electrical conductivity below about 11 dS/m.

In another embodiment of the citrus-based solvent remediation process of the present invention, the contaminated soil includes more than about 60 mg of soluble chloride per kilogram of soil and the recovered soil has bellow about 60 mg of soluble chloride per kilogram of recovered soil.

In another embodiment of the citrus-based solvent remediation process of the present invention, the process further comprises: (d) adding an aqueous solution to the recovered remediated soil of step (c) to form another mixture; (e) mixing the mixture of step (d) for a time sufficient to cause any amount remaining of contaminates in the recovered soil to separate from said recovered soil, and (f) recovering the soil from the mixture of step (d).

In another embodiment of the citrus-based solvent remediation process of the present invention, step (e) comprises subjecting the mixture of step (d) to ultrasonic energy for a time sufficient to cause the amount of remaining contaminates to separate from the recovered soil of step (c) into the aqueous solution.

In another embodiment of the citrus-based solvent remediation process of the present invention; step (f) comprises filtering the mixture of step (d) to separate the aqueous solution with the contaminates from the soil.

In another embodiment of the citrus-based solvent remediation process of the present invention, the process further comprises subjecting the aqueous solution to centrifugal forces thereby separating the contaminates from the aqueous solution.

In another embodiment of the citrus-based solvent remediation process of the present invention, the process further comprises subjecting the aqueous solution to a reverse osmosis process thereby obtaining a brine comprising inorganic contaminates and the aqueous solution substantially free of inorganic contaminates.

In one embodiment of any of the citrus-based solvent remediation processes of the present invention, the solution comprises at least about 10% of the citrus-based solvent and water.

In one embodiment of any of the citrus-based solvent remediation process of the present invention the citrus-based solvent comprises d-limonene.

### BRIEF DESCRIPTION OF THE DRAWINGS

The present invention will become more fully understood from the detailed description given herein and from the accompanying drawings, which are given by way of illustration only and do not limit the intended scope of the invention.

FIG. 1 is a table illustrating salinity analysis of soil, processed in accordance with one embodiment of the present invention.

FIG. 2 is a table illustrating metal analysis of soils processed in accordance with one embodiment of the present invention.

### DETAILED DESCRIPTION OF THE INVENTION

Unless defined otherwise, all technical and scientific term, used herein have the same meaning as commonly understood, by one of ordinary skill in the art to which this invention belongs. Also, unless indicated otherwise, except within the claims, the use of “or” includes “and” and vice-versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise.

### Overview

The present invention relates, in one embodiment, to methods of extracting crude oils and to remediation of contaminated soils. The extraction methods of the present invention may be based on in situ and above ground extraction of crude oils. Surface remediation may be continuous or a batch process.

By “heavy rude oils” is meant crude oil which do not flow easily or not flow at all (i.e. solid). As such, the term “heavy crude oil” as used in this document includes liquid petroleum with an API gravity below about 20°, liquid petroleum with API gravity below about 10.0° API (i.e. with a density greater than 1000 kg/ml. For the purpose of this document, the term “heavy crude oil” includes bitumen, which may be present as a solid and does not flow at ambient conditions. “API gravity” stands for American Petroleum Institute gravity, which is a measure of how heavy or light a type of petroleum is compared to water.

By “in situ” it is meant that the process takes place at the crude oil deposit or oil reservoir, and without extracting the crude oil from the crude oil deposit.

The term “hydrocarbon matrix” as used in this document refers to a raw or crude mixture which includes crude oil and a substrate. The crude oil may include heavy crude oil. The substrate may be a mixture of sand, sandstone, sedimentary rocks, clays, carbonate and so forth. Hydrocarbon matrices include, for example, oil sand or oil shale in are oil deposit and oil sand or oil shale taken or mined from an all deposit.

The term “media” as used in this document refers to substances capable of transferring ultrasonic energy from an ultrasonic transducer.

The term “oil deposit” refers to an area with reserves of recoverable crude oil or petroleum. Oil deposits include conventional oil deposits, shale oil deposits, oil sand deposits and carbonate oil reservoirs.

The term “recovery” as used in this documents means techniques for extracting crude oil from an oil deposit or reservoir.

### Hydrocarbon Extraction

In one embodiment, the present invention relates to the recovery or extraction of heavy crude oils, such as bitumen, from a hydrocarbon matrix.

In one embodiment, the extraction method of the present invention may include contacting the hydrocarbon matrix with a solution comprising a citrus-based solvent to create a mixture, and mixing the mixture. The heavy crude oils within the hydrocarbon matrix may be substantially separated from the hydrocarbon matrix, thereby recovering the heavy crude oils from the hydrocarbon matrix.

In one embodiment, the method for extracting heavy crude oil from a hydrocarbon matrix may include: (a) contacting the hydrocarbon matrix with a solution comprising a citrus based solvent to form a slurry; (b) subjecting the slurry to ultrasonic energy for a time sufficient to cause an amount of the heavy crude oil to separate from the hydrocarbon matrix; and (c) recovering said heavy crude oil.

The hydrocarbon matrix may be mixed with the citrus-based solvent in a mixing device, which may include a mixing vessel or an auger trough. For convenience, the term “vessel” may be used to include both mixing vessels and auger trough or any other suitable tanks in which the hydrocarbon matrix may be mixed with the citrus-based solvent. The vessel may be sized and scaled to match the requirements of the scope of extraction. This vessel can be used in incline flow or batch systems. Earth moving equipment may be used to deliver the hydrocarbon matrix from a remote site to the vessel.

An appropriate ultrasound transducer may be lowered into the mixing vessel or be attached onto the exterior of the mixing vessel, and the slurry may be subjected to an ultrasonic bath for a sufficient period of time. The duration of the ultrasonic bath may depend on the amount of hydrocarbon matrix being processed.

Typically, a range from about 1 kHz to about 80 kHz of ultrasonic energy may be used. However, a person of ordinary skill in the art may understand that less than 1 kHz or more than 80 kHz may be used. For example, 20 kHz to 60 kHz may be used. Industrial ultrasonic devices manufactured by Hielscher Ultrasonics GmbH may be used.

In one embodiment, the solution may include the citrus-based solvent and a suitable polar fluid. The solution may comprise at least about 10% of the citrus-based solvent. A solution comprising 10% to 100% of the citrus-based solvent may also be used. The polar substance may be any suitable polar substance such as water.

In one embodiment the ultrasonic bath may be stopped after a time sufficient to separate the heavy crude oil from the hydrocarbon matrix. Subjecting the slurry to ultrasonic energy may result in heavy crude oil being separated from the hydrocarbon matrix. The heavy oil hydrocarbons may be separated by flotation. The slurry may then be left for a time sufficient for the soil of the hydrocarbon matrix to settle at a bottom of the vessel so as to obtain a bottom fraction comprising of the matrix and a top fraction comprising the extracted heavy crude oil. The to fraction of the slurry, may then be removed as extracted heavy crude oil. In one embodiment, during the ultrasonic bath, heavy crude oil and citrus solvent may also be skimmed off the surface of the bath. Instead of being left to settle, in another embodiment, the heavy crude oil may be separated by subjecting the treated slurry to centrifugal forces so as to separate the matrix from the solvent and heavy crude oil, as it will be explained herein bellow.

In one embodiment, the above ultrasound step may be repeated by subjecting the ultrasonically treated hydrocarbon matrix to a second ultrasonic bath with fresh citrus-based solvent to further extract the heavy crude oil that may have not been removed during the first ultrasonic bath. In one embodiment, the second ultrasonic bath may be carried out with an aqueous solution in the presence or absence of the citrus-based solvent.

As previously provided, after the first ultrasonic bath or after subsequent ultrasonic baths, if provided, the ultrasonically treated slurry may be exposed to centrifugation so as to separate the soil of the matrix from the heavy crude oil. The supernatant including heavy crude oil may then be removed.

### In Situ Hydrocarbon Extraction

In one embodiment, the present invention relates to the in situ recovery of heavy crude oils, such as bitumen, from an oil deposit, such as oil sand, oil shale and carbonate oil reservoirs. Although the following examples may relate to the extraction of bitumen from oil sand matrices and deposits, it should be understood that the same method may be used to extract shale oil from an oil shale deposit or a carbonate oil deposit.

In one embodiment, the in situ extraction method of the present invention may include contacting the heavy crude oils in a deposit with a solution comprising a citrus-based solvent, for example by disposing the solution into the oil deposit, and subjecting the oil deposit having the solution to ultrasonic energy. The heavy crude oils within the deposit may be substantially separated in situ from the hydrocarbon matrix in the oil deposit and removed from the of deposit, thereby recovering the heavy crude oils from the oil deposit.

The in situ method of the present invention may be performed using a de novo hole, bore or well, by drilling a hole in the oil deposit, or it may be performed by using a previously used hole.

In one aspect of the present invention, the in situ method of the present invention may be performed to recover heavy crude oils from spent Steam Assisted Gravity Drainage (SAGD) wells.

In one embodiment of the present invention, the in situ method of extracting heavy crude oils from an oil deposit may start by contacting the hydrocarbons in the deposit with a solution comprising a citrus-based solvent. In one embodiment, the contacting may be accomplished by disposing or pouring the citrus-based solvent into the formation. In one aspect, the citrus-based solvent may be injected into the deposit. The citrus-based solvent may be disposed or poured into a well so as to reach the oil bed in the oil deposit. The method may continue by lowering an ultrasonic transducer through a well in the formation of the oil deposit and subjecting the heavy crude oil and poured solvent in the deposit to ultrasonic energy for a sufficient period of time. The heavy crude oils may then be extracted from the formation, for example by pumping the heavy crude oils up the well. The extracted hydrocarbons may then be sent for further processing and or upgrading. In this way, the formation absorbs the solvents without the need of added pressure.

An ultrasonic transducer may then be brought into the well and may contact with the citric-based solvent which has been poured into the well. From about 1 KHz to about 80 kHz of ultrasonic energy may be used. However, a person of ordinary skill in the art may understand that less than 1 kHz or more than 80 kHz may be used. When the ultrasonic transducer is turned on, the vibrations in the citric-based solvent or in the composition comprising the citric-based solvent may turn the citric-based solvent into an ultrasonic media which may dissolve the heavy crude oil in the oil deposit. The dissolved heavy crude oil may in turn create even more ultrasonic media which continues to spread further into the matrix of the oil deposit.

Furthermore, heat may be generated from this method as a result of exothermic reactions within the dissolving process. The citric-based solvent and ultrasonic vibrations may contribute in reducing the viscosity of the heavy crude oil which may flow through the perforations and then be pumped out of the well, thereby extracting the hydrocarbons (such as bitumen present in oil sands) in situ from the oil deposit.

Suitable citrus-based solvents may include, for example, d-limonene based degreasers available in the market, such as Citro Power, Ultrasolve H.D., Gold Degreaser, Trap-Float Degreaser.

In one embodiment, the citrus-based solvent may be provided in a solution that includes the citrus based solvent and a suitable polar fluid. The solution may comprise at least about 10% of the citrus-based solvent. A solution comprising 10-100% of the citrus-based solvent may also be used. The polar substance may be any suitable polar substance such as water.

Suitable ultrasound transducer to generate the sonic energy may include, for example Telsonic Ultrasonics™ transducer RS-25-48-B which produces ultrasonic waves in a cylindrical shape from the transducer.

The transducer needed to be connected to a line cable carrying the power from the surface to the payload section of the well. A suitable cable may be an HF silicone coaxial cable from Telsonic AG™. Example of power generators include ECO 2515R Ultrasonics generator from Telsonics Ultrasonics which may generate 25 Khz at 500 volts to drive the downhole transducer.

### Treatment of Contaminated Soils

The present invention describes also remediation methods for treating contaminated soil. The soil may be contaminated with one or more contaminants, including inorganic and/or organic pollutants.

In one embodiment the present invention describes a process for remediation of contaminated soil. The process, in one embodiment, comprises the steps of: (a) contacting contaminated soil with a solution comprising a citrus based solvent to form a slurry: (b) subjecting the slurry to ultrasonic energy for a time sufficient to cause an amount of the contaminates to separate from the soil; (c) removing said contaminates from the slurry; and (d) recovering said soil as remediated soil. The recovered soil may have less contaminates relative to the original contaminated soil.

In another embodiment of the present invention, a process for remediation of contaminated soil may include: (a) contacting the contaminated soil with a solution comprising a citrus based solvent to form a first slurry; (b) subjecting the first slurry to ultrasonic energy for a time sufficient to cause an amount of said contaminates to separate from the soil; (c) removing said contaminates from the first slurry and recovering the soil as treated soil; (d) adding an aqueous solution to the treated soil of step (c) to form a second slurry and mixing the second slurry for a time sufficient to cause an amount of remaining contaminates to separate from said treated soil; and (e) recovering the soil from the second slurry as remediated soil. The remediated soil may have less contaminates relative to the original contaminated soil.

The soil may be contaminated with inorganic pollutants such as salts and metals, and/or with organic pollutants, such as oil hydrocarbons.

The contaminated soil may be mixed with the citrus-based solvent in a mixing device, which may include a mixing vessel or an auger trough. For convenience, the term “vessel” may be used to include both mixing vessels and auger trough or any other suitable tanks in which the contaminated soils may be mixed with the citrus-based solvent. A supply member, such as an input pipe may be used to deliver fresh water into the vessel, and a drain pipe may be used for removing water from the vessel. The vessel may be sized and scaled to match the requirements of the scope of contamination. This vessel can be used in in-line flow or batch systems. Earth moving equipment may be used to deliver the contaminated soils from a remote site to the vessel.

An appropriate ultrasound transducer may be lowered into the mixing vessel or be attached onto the exterior of the mixing vessel, and the slurry may be subjected to an ultrasonic bath for a sufficient period of time. The duration of the ultrasonic bath may depend on the amount of soil being processed. During the ultrasound processing, fresh water may be added into the vessel, for example through the supply member, and contaminated water may be removed from the vessel, for example through the drain pipe.

Typically, a range from about 1 kHz to about 80 kHz of ultrasonic energy may be used. However, a person of ordinary skill in the art may understand that less than 1 kHz or more than 80 kHz may be used. For example, 20 kHz to 60 kHz may be used. Industrial ultrasonic devices manufactured by Hieischer Ultrasonics GmbH may be used.

In one embodiment, the solution may include the citrus-based solvent and a suitable polar fluid. The solution may comprise at least about 10% of the citrus-based solvent. A solution comprising 100% of the citrus-based solvent may also be used. The polar substance may be any suitable polar substance such as water.

In one embodiment the ultrasonic bath may be stopped after a time sufficient to separate contaminates from the soil. Subjecting the slurry to ultrasonic energy may result in contaminants or pollutants being separated from the soil. Organic pollutants such as oil hydrocarbons may be separated by flotation. The slurry may then be left for a time sufficient for the soil to settle at a bottom of the vessel so as to obtain a bottom fraction comprising of the soil and a top fraction comprising the organic contaminates. The top fraction of the slurry, which may include organic contaminates and inorganic contaminates, may then be removed, thereby leaving the soil with less contaminates than the original contaminated soil. In one embodiment, during the ultrasonic bath, organic contaminants and citrus solvent may also be skimmed of the surface of the bath. Instead of being left to settle, in another embodiment, the contaminates may be separated by subjecting the treated slurry to centrifugal forces so as to separate the soil from the solvent and contaminates, as it will be explained herein bellow.

In one embodiment, the above ultrasound step may be repeated by subjecting the ultrasonically treated soil to a second or more ultrasonic baths with fresh citrus-based solvent to further remove the contaminates that may have not been removed during the first ultrasonic bath. In one embodiment, the second or more ultrasonic baths may be carried out with an aqueous solution in the presence or absence of the citrus-based solvent.

As previously provided, after the first ultrasonic bath or after subsequent ultrasonic baths, if provided, the ultrasonically treated slurry may be exposed to centrifugation so as to separate the soil from contaminates. The supernatant may then be discarded, leaving the soil sediment or precipitate with less contaminates than the original contaminated samples. In aspects of the invention, the soil sediments may have a level of contaminates that may meet environmental standards, such as Alberta Tier 1 Soil and Groundwater Remediation Guidelines.

At any time during the process, the soil may be tested for contaminants, organic and/or inorganic. If the soil contains contaminants, then the method may be repeated from the first bath or from the second bath.

During the baths, the inorganic contaminates such as salt and/or metal contaminates may be separated form the soil. As such, the solutions used in the baths may include the salts and/or metal contaminants as well as other solid particles. This contaminated solution may be placed in a filter press and may be centrifuged to separate the inorganic particles from the water.

The aqueous solution contaminated with the salts and/or metals may then be run through a reverse osmosis process or it may be filtered resulting in substantially clean aqueous solution and a brine comprising mainly of salts and/or metals.

The clean solution from the reverse osmosis reclamation may then be returned to the original bath and rinse cycles.

The resultant brine from the reverse osmosis process may be stored and later evaporated to recover valuable salts and/or metal.

Materials and instruments that may be needed to carry out the treatment of soils in accordance with embodiments of this invention, include:

1. Earth moving equipment;

2. conveyor to move soil;

3. trough or tanks containing an aqueous slurry with citrus-based solvent;

4. ultrasonic transducers on or in the trough or tanks;

5. a skimming mechanism to remove organic contaminants from the top of the slurry;

6. a second trough or tanks and slurry with ultrasonics and clean water for a rinse;

7. a centrifuge;

8. a reverse osmosis process;

9. an earth moving equipment to move the dirt back into place;

10. a variety of control and metering equipment; and

11. a filter press.

The soil remediation process of the present invention may be performed at a site, and the method may further include the steps of: (i) removing the contaminated soil from a place remote from the site; and (ii) transporting the contaminated soil sample to the site for remediation processing. The remediated soil, or at least some of the remediated soil, may then be returned to the original site from where it was taken.

### ADVANTAGES

Advantages of the present invention include;

### in Situ Extraction of Hydrocarbons

There are many SAGD-treated and chops wells that will only extract a minor percentage of oil from in situ formations. Many of these wells will be contaminated with water and be quite warm. As a result, many of these wells have been abandoned and are now accessible and ideal far further of extraction with the method of the present invention, in cases where there is a high level of water present as a result of previous SAGD or high water levels present, the present invention serves to extract further oil products economically and with low environmental impact.

### Treatment of Contaminated Soils

At present there is a need for an efficient and environmentally friendly way of separating inorganic and/or organic pollutants from dirt and sand. This problem has caused major expenses and difficulties in clean-ups of oil spill and various other toxic and contaminated sites. Usually, dirt and contaminated media must be transported to toxic waste sites or buried. The treatment of contaminated soil in accordance with the present invention is an inexpensive way of separating and treating contaminated soil so that the soil can meet environmental standards in order to be returned to their original locations and not require burial or transportation to toxic waste sites.

Heavy metals and other contaminants found in these spill sites may also be removed from soil with the present methods. Since water, mixed with citrus based solvents, as a sonic media to treat the contaminated soil, including sands, the removal of toxic salts and/or organic pollutants may be done in one continuous process.

The machinery and equipment required to conduct clean-ups of spillage sites is sufficiently small and portable that it can be taken to most sites where soils can be treated and cleaned to meet environmental standards in order to be returned to their original location.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Materials and Methods

Testing was done using three different samples of soil, from a contaminated oil well site in northern Alberta.

The samples were labelled as follows (jar number-soil type): 003(x)-55—Saline Sand, 003(x)-05B—Oil Saline Mixture, and 003(x)-HC—Hydrocarbon contaminated soil.

Sample A—pre-treatment or untreated sample.

Sample B—post-treatment treated sample.

The treatment roses consisted of:

1) Place 200 grams of untreated soil in a jar and filling the jar with mixture of Citra-solve™ and water 1 litre total ⅔ water ⅓ Citra.solve™.

Citra-solve™ is a citrus based d-Limonene derived degreaser.

2) Place jar in ultrasonic 60 Hz bath for 15 min.

3) Contents within jar were mixed every 5 min.

4) Turn ultrasonics off, let contents settle for 2 min. and pour out the liquid mixture off the settled soil.

5) Re-Fill the jar to 1 litre line with fresh water, stir and then pour the liquid off.

6) Let the soil in the jars air dry overnight and seal jars.

Samples treated under this process include (Jar Number—Soil type): 003E 55B, 003E-05B-B1 and 003D-1-HCB.

There was one test of the O58 mixture that was done in test tubes instead of a jar, and the test tubes were placed in a centrifuge instead of allowing separation based on settling. This mixture is sample number 003G-05B-B2, 003G-05B-B2 was centrifuged for 10 min.

Treated and untreated samples were sent to AGAT Laboratories (Calgary, Alberta) for salinity analysis.

### Results

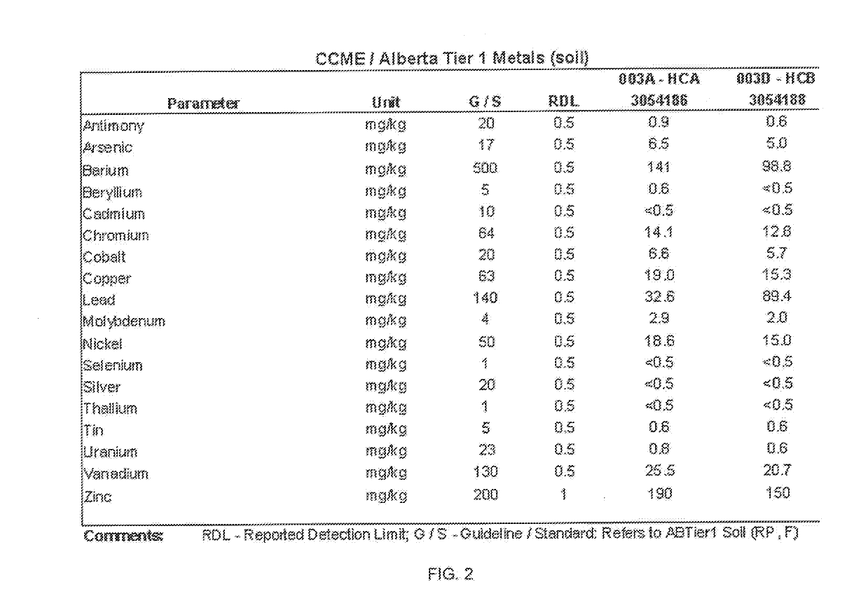

In the case of technology applications for soil remediation of oil field waste, specific attention is paid to the reduction in salinity, such as chloride ions, and petroleum hydrocarbons, as these are the most common contaminants of concern. Metal analysis was also completed (see FIG. 2).

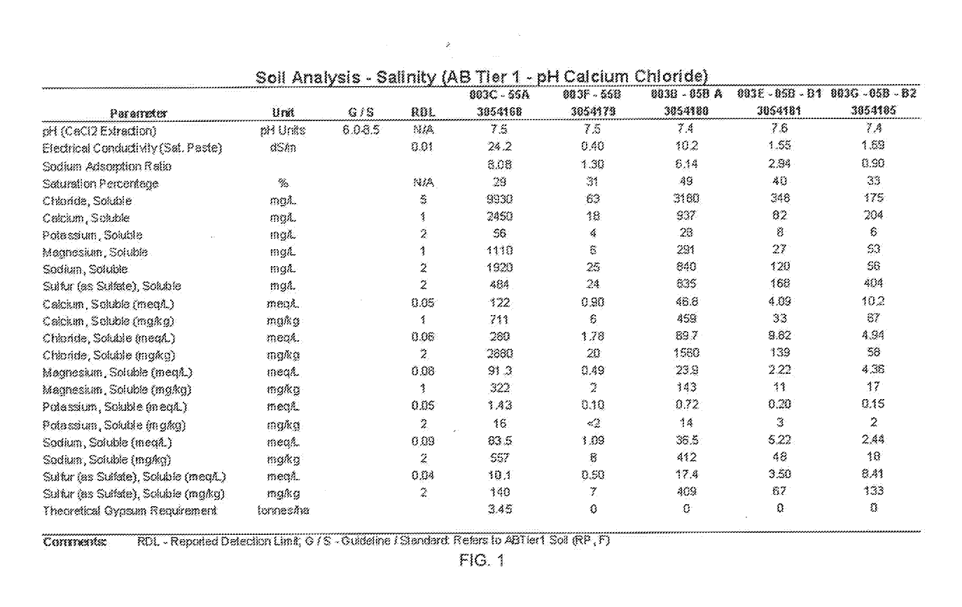

The table presented in FIG. 1 illustrates the salinity analysis of samples 003C-56A (untreated saline sand), 003F-55B (treated saline sand), 0038-05B A (untreated oil saline mixture), 003E-058-B1 (treated oil saline mixture), and 003S-06B-B2 (treated oil saline mixture plus centrifugation);

1) Reduced salinity was observed in all three treated samples.

2) Electrical conductivity was reduced from 24.2 (003C-55A) to 0.4 (003F-55B) and, from 10.2 (C.)003B-05B A) to 1.55, and 1.69 for 003E-05B B1 and 003G-05B-B2 respectively.

3) Soluble chloride reduced from 2880 (003C-55A) to 20 (003F-55B), and 1560 (0038-0513 A) to 139 (003E 05E 81), and 58 (003G-058—B2).

4) All soluble ions were reduced in the treated samples.

### Conclusions

A treatment process using ultrasonics and solvent mixture having Citra-solve™ indicate usefulness of the solvent solution and the treatment process in remedial applications for saline soils, as well as applications in hydrocarbon impacted soils. Further work is currently underway to obtain hydrocarbon analysis of treated soils, to understand the nature of this separation method, as well as optimizing the nature of the solvent used, in for the separation of inorganic and/or organic contaminants.

I claim:

1. A method of extracting hydrocarbons from a hydrocarbon matrix, the method comprising: (a) contacting the hydrocarbon matrix with a solution comprising a citrus based solvent to form a mixture, (b) subjecting the mixture to ultrasonic energy, and (c) extracting the hydrocarbons from the hydrocarbon matrix.

2. The method of claim 1, wherein prior to step (a) the method comprises mining the hydrocarbon matrix from an oil deposit.

3. The method of claim 1, wherein the hydrocarbon matrix is in an oil deposit.

4. The method of claim 3, wherein step (a) comprises contacting the hydrocarbon matrix in the oil deposit with the solution comprising a citrus based solvent; step (b) comprises subjecting the oil deposit having the citrus-based solvent to the ultrasonic energy; and step (c) comprises extracting the hydrocarbons from the oil deposit.

5. The method of claim 3, wherein the oil deposit includes water.

6. The method of claim 3, wherein the oil deposit includes a spent Steam Assisted Gravity Drainage (SAGD) well, and wherein step (a) comprises pouring or injecting the citrus-based solvent into the spent SAGD well; step (b) comprises subjecting the oil deposit having the citrus-based solvent to the ultrasonic energy; and step (c) comprises extracting the hydrocarbons from the oil deposit.

7. The method of claim 1, wherein the hydrocarbon include heavy crude oils.

8. The method of claim 3, wherein the hydrocarbon include heavy crude oils.

9. The method of claim 3, wherein the oil deposit is selected from shale oil deposit, oil sand deposit or carbonate oil reservoirs.

10. The method of claim wherein the solution comprises at least about 10% of the citrus-based solvent and water.

11. The method of claim 1, wherein the citrus-based solvent comprises d-limonene.

12. The method of claim 3, wherein the solution comprises at least about 10% of the citrus based solvent and water.

13. The method of claim 3, wherein the citrus-based solvent comprises d-limonene.
